(19) United States
(12) Patent Application Publication
(10) Pub. No.: US 2023/0415527 A1
(43) Pub. Date: Dec. 28, 2023

(54) Weight Distribution Hitch

(71) Applicant: Philip Wyers, Centennial, CO (US)

(72) Inventor: Philip Wyers, Centennial, CO (US)

(21) Appl. No.: 18/324,073

(22) Filed: May 25, 2023

Related U.S. Application Data
(60) Provisional application No. 63/365,312, filed on May 25, 2022.

(51) Int. Cl. B60D 1/24; B60D 1/167; B60D 1/06

(52) U.S. Cl. CPC B60D 1/247; B60D 1/167; B60D 1/065; B60D 1/30

(57) ABSTRACT

An improved weight distribution hitch having a pair of improved torsion brackets that are configured for vertical dynamic adjustment of the torsion arms relative to the towed vehicle, or trailer, frame. Each torsion bracket has a frame bracket that mounts to the A frame of a trailer. The frame bracket fixedly mounts to the A frame of the trailer. A torsion arm bracket is connected to the frame bracket and configured for vertical movement within the frame bracket to adjust the relative position of the torsion arms to the frame bracket, and thus the A frame of the trailer. The actuator preferably is an actuator bolt that is positioned through the frame bracket, and configured to rotate. The actuator bolt is threadingly engaged with the torsion arm bracket such that rotation of the actuator bolt vertically moves the torsion arm bracket relative to the frame bracket.

### CROSS-REFERENCE TO RELATED APPLICATIONS

This application claims the benefit of U.S. Provisional Application No. 63/365,312, filed May 25, 2022 the disclosure of which is incorporated by reference.

### FIELD OF THE INVENTION

The presently disclosed technology relates to an improved weight distribution hitch for use when towing a trailer by a vehicle. More particularly, the present invention is an improved weight distribution hitch having dynamic adjustment of the positioning of the torsion bars to the

[symbol]

### BACKGROUND OF THE INVENTION

An improved sway control bracket for use with a weight distribution hitch system is disclosed. Weight distribution hitches (also called a load-equalizing hitch) are utilized to distribute the tongue weight of a towed vehicle, such as a travel trailer, across the wheels of a towing vehicle.

Typically a weight distribution hitch is attached to the towing vehicle at a receiver. The shank of the weight distribution hitch inserts into the receiver and is coupled to the receiver. The weight distribution hitch extends rearward from the vehicle typically to a hitch ball. Typically two torsion bars extend from the weight distribution hitch on opposite sides of the hitch ball. Most weight distribution hitches are vertically adjustable to allow for vertical adjustment of the hitch ball and torsion bar attachment points of the hitch relative to the receiver of the towing vehicle. Some weight distribution hitches also allow for rotational adjustment of the hitch ball and torsion arm attachment points. This allows a user to alter the height and/or angle of the hitch ball and torsion bar attachment points when load is not positioned on the hitch, such that when the load of the trailer tongue is positioned on the hitch ball, the receiver hitch and

The tongue of the trailer is typically shaped in an A shape, with a female coupler configured to placement on the hitch ball of the weight distribution hitch. The torsion bars are connected to a torsion arm frame bracket positioned on each of the arms of the A shaped trailer tongue.

The frame brackets have two opposing plates that are positioned on an arm of the A-frame. The opposing plates are connected by bracket bolts that extend through each plate above the frame arm and below the frame arm, connecting the bracket to the arm of the A-frame. Preferably each plate has a series of bracket bolt openings allowing for the plates to provide for vertical positioning on the trailer frame. The torsion bars are connected to the bracket either by a chain that extends from the end of the torsion bar upward to the bracket, or alternatively by a torsion bar connector bracket that is attached to the outer plate and extends beneath the outer plate and below the frame of the trailer tongue. Such a connector is shown, for example, the Curt® weight distribution hitch product no. 17499.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is an improved weight distribution hitch having an improved torsion bracket for connecting a torsion arm to the frame of the tongue of the trailer. The torsion bracket has a frame bracket that is configured for attachment to an arm of the A-frame of a typical trailer tongue by bracket bolts and a torsion arm bracket that is slidably positioned in the frame bracket to allow for vertical, dynamic adjustment of the torsion arm bracket in the stationary mounted frame bracket. This adjustment mechanism allows for the adjustment of the weight distribution hitch while the towed vehicle and towing vehicle are attached with load applied to the hitch, as opposed to prior mechanisms which required at least removing the load and uncoupling the torsion arms from the prior torsion brackets.

Preferably the frame bracket is configured for attachment by bolts to the frame of the A-frame of the trailer tongue. In a preferred embodiment the frame bracket has two opposing plates that have corresponding bracket bolt openings to allow for a bracket bolt to be positioned through an opening in one plate and extend through the corresponding opening in the second plate. Preferably a series of openings is configured in each plate to allow for selective vertical positioning of the plates, and thus the frame bracket, on the frame of the tongue of the trailer. The torsion arm bracket is configured for vertical adjustment relative to the frame bracket. The torsion arm bracket extends beneath the frame bracket and is configured to retain the end of the torsion arm connected to the torsion arm bracket.

An elongate channel extends longitudinally along the outer plate of the outer plate of the frame bracket. The body of the torsion arm bracket is positioned within the longitudinal channel. The top of the outer plate is configured for placement therethrough of a bolt or screw such that the head of the bolt is positioned at a top of the plate, while the threaded body of the bolt extends into the channel and into the body of the torsion arm bracket. The body of the torsion arm bracket defines a threaded channel configured for threaded engagement with the shaft of the bolt. The bolt is stationary in the outer plate of the body such that rotation of the bolt causes the body of the torsion arm bracket to vertically move in the channel in the outer plate of the body, adjusting the position of the bracket holding the torsion arm relative to the frame bracket. Alternate vertical adjustment mechanisms can be utilized, such as a worm drive.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature

### BRIEF DESCRIPTION OF DRAWINGS

FIG. 1 illustrates a first perspective view of a preferred embodiment of a weight distribution hitch connected to the A-frame of a towed vehicle.

FIG. 2 illustrates a second perspective view of a preferred embodiment of the weight distribution hitch depicted in FIG. 1 connected to the A-frame of a towed vehicle.

FIG. 3 illustrates a top view of a preferred embodiment of the weight distribution hitch depicted in FIG. 1 connected to the A-frame of a towed vehicle.

FIG. 4 illustrates a third perspective view of a preferred embodiment of the weight distribution hitch depicted in FIG. 1 connected to the A-frame of a towed vehicle.

FIG. 5 illustrates a first side view of a preferred embodiment of the weight distribution hitch depicted in FIG. 1 connected to the A-frame of a towed vehicle.

FIG. 6 illustrates a front view of a preferred embodiment of the weight distribution hitch depicted in FIG. 1 connected to the A-frame of a towed vehicle.

FIG. 7 illustrates a second side view of a preferred embodiment of the weight distribution hitch depicted in FIG. 1 connected to the A-frame of a towed vehicle.

FIG. 8 illustrates a side view of the improved weight distribution hitch of FIG. 1 with the A-frame of the towed vehicle removed.

FIG. 9 illustrates a perspective view of the improved weight distribution hitch of FIG. 1 with the A-frame of the towed vehicle removed.

FIG. 10 illustrates a first perspective view of a preferred embodiment of a torsion bracket.

FIG. 11 illustrates a second perspective view of a preferred embodiment of a torsion bracket illustrated in FIG. 10.

FIG. 12 illustrates a side view of a preferred embodiment of a torsion bracket illustrated in FIG. 10.

FIG. 13 illustrates a preferred embodiment of a drop bar, pivot block, and ball mount having torsion bars attached thereto.

FIG. 14 illustrates a preferred embodiment of a drop bar, pivot block, and ball mount.

### DETAILED DESCRIPTION OF THE INVENTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

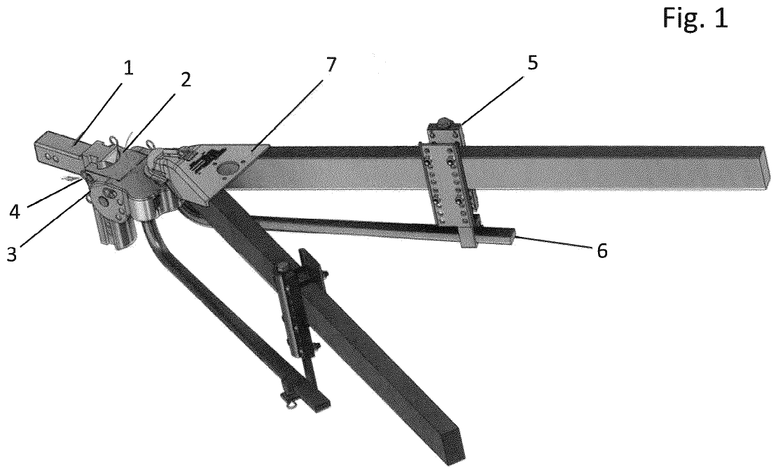

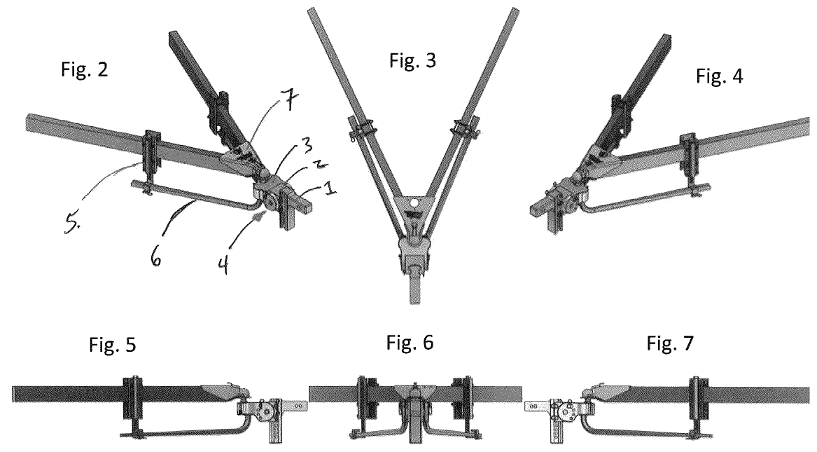

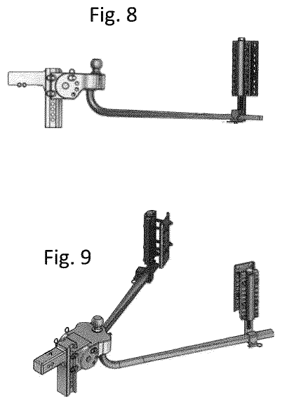

FIG. 1 illustrates a preferred embodiment of a weight distribution hitch connected to the A frame assembly 7 of a trailer. The weight distribution hitch has a drop bar 1 that connects to the receiver of a towing vehicle. The depicted drop bar is connected to a pivot block that is vertically adjustable on the drop bar. The pivot block 2 is pivotally connected to a ball mount 3, forming the ball mount pivot assembly. Two torsion bars 6 extend from the ball mount.

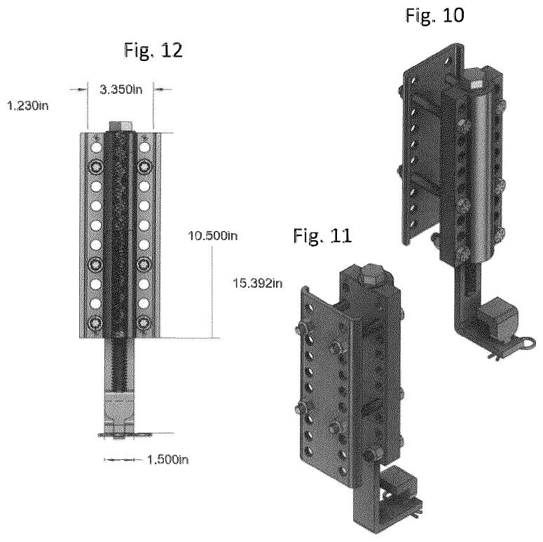

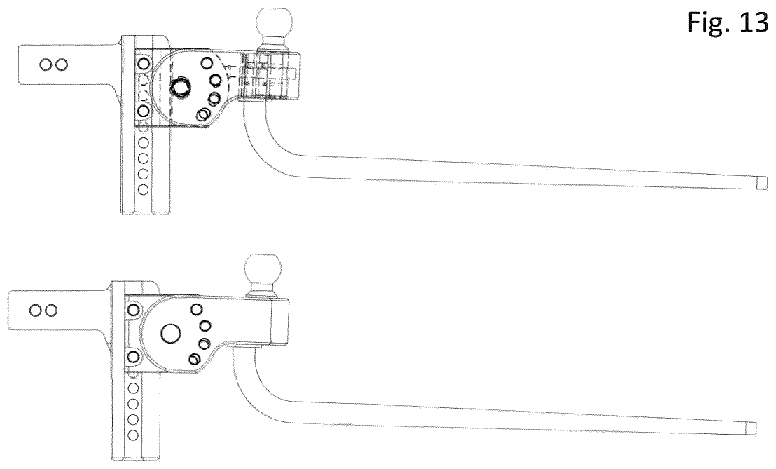

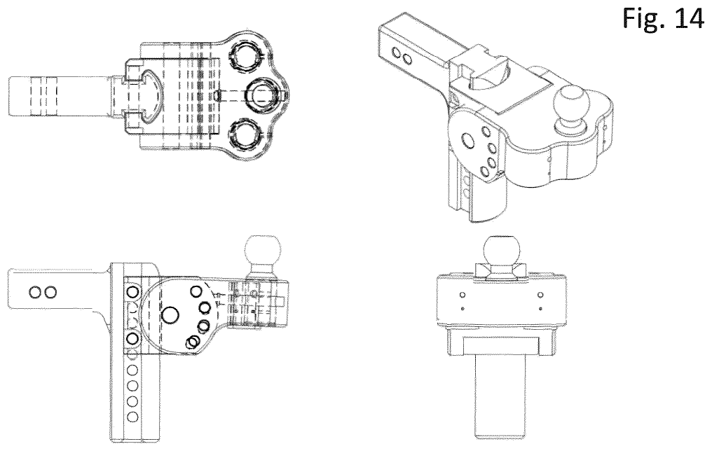

The torsion bracket 5 has a torsion arm bracket that is connected to the frame bracket. The torsion arm bracket is configured for vertical adjustment relative to the frame bracket. The torsion arm bracket extends beneath the frame bracket and is configured to retain the end of the torsion arm to the torsion arm bracket. A preferred embodiment of the torsion bracket is shown in increased detail in FIGS. 10-12.

Four through bolts retain the opposing plates of the frame bracket on the frame of the trailer. An elongate longitudinal channel extends longitudinally along the outer plate of the outer plate of the frame bracket. The body of the torsion arm bracket is positioned within this longitudinal channel and configured to vertically move up or down when the torsion arm bracket actuator is actuated.

In a preferred embodiment the torsion arm bracket actuator is an adjustment bolt that extends through a top plate of the frame bracket and threadingly engages the torsion arm bracket. The top of the outer plate of the frame bracket has an opening that retains the head of the adjustment bolt on the opposing side of the top plate of the frame bracket from the torsion arm bracket. The adjustment bolt or screw is positioned such that the head of the adjustment bolt is positioned on top of the plate, while the threaded body of the adjustment bolt extends into the channel and into the body of the torsion arm bracket.

The body of the torsion arm bracket defines a threaded channel configured for threaded engagement with the threaded shaft of the adjustment bolt. The adjustment bolt is vertically stationary in the outer plate of the frame bracket body such that rotation of the adjustment bolt causes the body of the torsion arm bracket to vertically move in the channel in the outer plate of the body, adjusting the vertical position of the torsion arm bracket relative to the frame bracket.

Alternate lifting mechanisms can be utilized to adjust the torsion arm bracket vertically in relation to the frame bracket. For example, a worm gear apparatus can be utilized. The vertical adjustment of the torsion arm bracket relative to the frame bracket allows for adjustment of the weight distribution hitch system without having to remove the torsion arm bracket. This adjustment mechanism allows for adjustment of the torsion arm bracket under load. This can be beneficial, for example, for adjusting the weight distribution hitch system after weight is added to or removed from the trailer.

The distal end of the torsion arm bracket is configured to retain a torsion bar. In a preferred embodiment, an inverted L-shaped bracket attached to the distal (or second) end of the torsion arm bracket. The distal or lower end of the torsion arm bracket is formed in an L-shape, with the inverted bracket and lower end of the torsion arm forming a bracket to retain the torsion arm. The inverted L-shaped bracket is preferably retained by a pin that secures a flange of the inverted L-shaped bracket that passes through an opening in the distal end of the torsion arm bracket.

What is further disclosed is a weight distribution hitch having a pivot head. The hitch has a drop bar 1 configured for insertion into a receiver. The drop bar is attached to a vertically adjustable pivot block. The pivot block is attached to a ball mount. The ball mount is connected to the pivot block 2 by a ball mount pivot assembly 4 having a pivot pin to allow the ball mount to rotationally pivot on the pin. The rotational pivot allows for adjustment of the angle of the ball mount and the ball attached thereto relative to the pivot block and thus the vehicle. The ball mount has a series of holes positioned at the same radial distance from the pivot pin. As the ball mount is rotated about the pivot pin, the holes sequentially align with one or more retention holes in the pivot block of the weight distribution hitch such that one or more pins is positioned through the openings to secure the rotational position of the ball mount relative to the pivot block. The torsion bars extend from the ball mount rearward to be attached preferably to the torsion bar adjustment brackets disclosed herein. Preferably the torsion arms are modular and removable from ball mount to allow for varying torsion bars to be utilized depending, for example, on the weight of the trailer to be towed.

While the components can be utilized independently, the simplicity of the ball mount pivot assembly utilizing one or more pins to retain the pivot in position, coupled with the simple adjustability of the torsion bar adjustment brackets make for easy and simple installation and adjustment. This facilitates quick setup for a trailer, and quick set up when moving the weight distribution hitch setup between vehicles. In prior art hitches to adjust the pivot head typically requires at least two to four bolts that must be tightened to adjust the torsion bar angles, if not moved and tightened. The currently disclosed pivot head allows for changing angles simply by the removal of a pin and rotation of the pivot head

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A weight distribution hitch comprising:
a shank and ball mount, said shank configured for insertion into a receiver of a tow vehicle;
two torsion bars extending from said shank and ball mount;
two torsion brackets configured for attachment to a trailer frame, wherein each of said torsion brackets comprising a frame bracket and a torsion arm bracket, wherein each torsion arm bracket is connected to one of said torsion bars, wherein the frame bracket is fixedly attached to the trailer frame and the torsion arm bracket is attached to said frame bracket so as to be vertically moveable within the frame bracket;
a torsion arm bracket actuator configured to cause the torsion arm bracket to vertically move within in the frame bracket, wherein said torsion arm bracket is vertically immovable unless actuated by said torsion arm bracket actuator.

2. The weight distribution hitch of claim 1, wherein said torsion arm bracket actuator comprises an adjustment bolt extending from a top of said frame bracket to said torsion arm bracket, wherein said adjustment bolt is threadingly engaged with said torsion arm bracket such that rotation of said adjustment bolt vertically moves said torsion bracket relative to said frame bracket.

3. The weight distribution hitch of claim 1, wherein said ball mount is configured to pivot relative to said shank.

4. The weight distribution hitch of claim 1 wherein said torsion arm bracket actuator comprises a worm gear.
